(19) United States
(12) Patent Application Publication
(10) Pub. No.: US 2008/0123496 A1
(43) Pub. Date: May 29, 2008

(54) SIGNAL PROCESSING DEVICE AND OPTICAL DISC PLAYBACK APPARATUS

(76) Inventors: Takeshi ODA, Kyoto (JP); Mitsuhiro MATSUMURA, Kyoto (JP)

Correspondence Address: MCDERMOTT WILL & EMERY LLP, 600 13TH STREET, NW, WASHINGTON, DC, 20005-3096, US

(21) Appl. No.: 11/945,453

(22) Filed: Nov. 27, 2007

(30) Foreign Application Priority Data
Nov. 27, 2006 (JP) 2006-318292

(51) Int. Cl. G11B 7/00; G11B 20/18

(52) U.S. Cl. 369/53.23

(57) ABSTRACT

In a signal processing device, a 3-beam TE signal generation circuit generates a tracking error signal by a 3-beam method (3-beam tracking error signal), and a DPD TE signal generation circuit generates a tracking error signal by a DPD method (DPD tracking error signal). A TE signal variation detection circuit detects a variation in 3-beam tracking error signal. A TE signal generation method switch circuit selects and outputs the 3-beam tracking error signal initially, and if the TE signal variation detection circuit detects a variation, selects and outputs the DPD tracking error signal.

### CROSS-REFERENCE TO RELATED APPLICATIONS

This application claims priority under 35 U.S.C. § 119 on Patent Application No. 2006-318292 filed in Japan on Nov. 27, 2006, the entire contents of which are hereby incorporated by reference.

### BACKGROUND OF THE INVENTION

1. Field of the Invention

The present invention relates to a signal processing device for generating a tracking error signal in an optical disc playback apparatus for playing back optical information on a disc-shaped recording medium using laser light and the like.

2. Description of the Prior Art

In recent years, as information playback apparatuses for audio and the like, optical disc playback apparatuses using digital media such as CDs (Compact Discs), MDs (Mini Discs) and DVDs (Digital Versatile Discs) have become widespread.

To read information from a disc accurately in an optical disc playback apparatus, laser light emitted from an optical pickup to come into a focus on the disc must trace a track on the disc, along which a signal is recorded, accurately. For this purpose, the optical disc playback apparatus is provided with a focus servo control mechanism and a tracking servo control mechanism for control of the position of the optical pickup.

The focus servo control and the tracking servo control are meant to control the position of the optical pickup in the vertical and horizontal directions, respectively, with respect to the disc signal plane.

As for the tracking in optical disc playback apparatuses, various tracking methods are known including a 3-beam method and a differential phase detection (DPD) method (see Japanese Patent Publication for Opposition No. 2-56734 (Patent Document 1)).

FIGS. 24A to 24C are views illustrating the 3-beam tracking method. In the 3-beam tracking method, before and after a 0-order light ray as the main beam for readout of a signal on a track, ±1-order light rays as two sub-beams are positioned to sandwich the track therebetween. Reflected light rays of the main beam and sub-beams are received by a photodetector (PD).

The photodetector includes a light-receiving element 901 for +1-order light, a light-receiving element 903 for −1-order light and a four-quadrant light-receiving element 902 for 0-order light.

The outputs of the light-receiving elements 901 and 903 are inputted to the non-inverting input terminal and inverting input terminal of a differential amplifier 904, which then outputs the subtraction result as a tracking error (TE) signal. When the output of the differential amplifier 904 is a positive value, the beam spots on the track are as shown in FIG. 24B. Likewise, when the output of the differential amplifier 904 is a negative value, the beam spots on the track are as shown in FIG. 24C, and when it is 0, they are as shown in FIG. 24A. That is, from these detection results, information on the side on which the beam spots are deviated with respect to the track, as well as the deviation amount, can be obtained.

FIG. 25 is a view illustrating tracking by the DPD method, which uses one beam to obtain a TE signal.

In the DPD method, four quadrant light-receiving elements A, B, C and D separated from one another with a line horizontal to a tangent of a track and a line orthogonal to the horizontal line are prepared. A phase difference Δt between diagonal sum signals (A+C) and (B+D) among the elements A, B, C and D is detected, to obtain a tracking error voltage as a voltage proportional to this phase difference.

The DPD method, which obtains the TE signal according to the phase difference between diagonal sum signals, unlike the 3-beam method obtaining the TE signal from a change in light intensity distribution, has an advantage of being highly resistant to occurrence of a DC offset with tilting of an optical disc.

In the DPD method, however, the quality of the TE signal sometimes changes with the pit depth. Therefore, as the tracking method for CD media for which the pit depth has not been defined, the 3-beam method has been adopted.

Optical disc playback apparatuses as described above have a problem as follows. As shown in FIG. 26, if an object lens 915 is in such a state that the extension of the travel path thereof that is parallel to a support shaft 913 does not intersect the center axis 912 of a spindle 911, it will become impossible to record an information signal on an optical disc 910 accurately or play back an information signal recorded on the optical disc accurately.

To state more specifically, if the extension of the travel path of the object lens 915 fails to intersect the center axis 912 of the spindle 911, the direction of the tangent of a recording track formed on the optical disc 910 with respect to the position of optical pickup 914 will change as the optical pickup 914 is moved over the inner to outer peripheries of the optical disc 910.

The direction of the tangent of a recording track at the position above which the object lens 915 is located changes with the angle formed between a straight line that is parallel to the travel path of the optical pickup 914 and intersects the center axis 912 of the spindle 911 and a straight line connecting the center axis 912 of the spindle 911 and the optical axis of the object lens 915. For example, in FIG. 26, when the object lens 915 is at position P1, position P2 and position P3, the relationship between the three beams and a track will be as shown in (a), (b) and (c), respectively. The reflected light will therefore change with the position of the object lens 915.

In particular, when the optical pickup 914 adopts the 3-beam method to generate a TE signal, no good TE signal will be obtainable and thus tracking will fail. Therefore, it will become impossible to play back an information signal recorded on the optical disc 910 accurately. This problem will especially be eminent when an eccentric disc and a disc narrow in track pitch are used.

To overcome the above problem, there is disclosed an optical disc playback apparatus configured to adjust the mount position of the support shaft 913 to perform so-called tangential adjustment in which the extension of the travel path of the object lens 915 is made to intersect the center axis of the spindle 911 (see Japanese Laid-Open Patent Publication No. 4-328333 (Patent Document 2), for example).

However, the work of adjusting the mount position of the support shaft 913 as described in Patent Document 2 is complicated, and thus the tangential adjustment will not be made easily.

### SUMMARY OF THE INVENTION

An object of the present invention is providing a signal processing device capable of generating a stable tracking error signal.

To attain the above object, the 3-beam method is initially adopted to generate a tracking error signal, and once deterioration or variation is detected in tracking error signal, the tracking error generation method is switched from the 3-beam method to the DPD method.

The signal processing device of the present invention includes: a 3-beam TE signal generation circuit for generating a 3-beam tracking error signal as a tracking error signal by a 3-beam method; a DPD TE signal generation circuit for generating a DPD tracking error signal as a tracking error signal by a DPD method; a TE signal variation detection circuit for detecting a variation in the 3-beam tracking error signal; and a TE signal generation method switch circuit receiving the 3-beam tracking error signal and the DPD tracking error signal for selecting and outputting the 3-beam tracking error signal initially and, if the TE signal variation detection circuit detects a variation, selecting and outputting the DPD tracking error signal.

### BRIEF DESCRIPTION OF THE DRAWINGS

FIG. 1 is a block diagram of an optical disc playback apparatus 100 of Embodiment 1 of the present invention.

FIG. 2 is a view showing the relationship among an RF signal, an OFTR signal and a detection threshold.

FIG. 3 is a view showing the relationship among a TE signal, a TKC signal and a detection threshold.

FIG. 4 is a view showing average values of the TE signal in a predetermined time.

FIG. 5 is a flowchart illustrating the operation of the optical disc playback apparatus 100 of Embodiment 1.

FIG. 6 is a block diagram of an optical disc playback apparatus 200 of Embodiment 2 of the present invention.

FIG. 7 is a view illustrating generation of a TEENV signal.

FIG. 8 is a flowchart illustrating the operation of the optical disc playback apparatus 200 of Embodiment 2.

FIG. 9 is a view showing the phase relationship between the OFTR signal and the TKC signal.

FIG. 10 is a block diagram of an optical disc playback apparatus 300 of Embodiment 3 of the present invention.

FIG. 11 is a flowchart illustrating the operation of the optical disc playback apparatus 300 of Embodiment 3.

FIG. 12 is a view illustrating setting of a threshold by a DC following threshold scheme.

FIG. 13 is a view illustrating setting of a threshold by a fixed threshold scheme.

FIG. 14 is a flowchart illustrating the operation of an optical disc playback apparatus 400 of Embodiment 4 of the present invention.

FIG. 15 is a block diagram of an optical disc playback apparatus 500 of Embodiment 5 of the present invention.

FIG. 16 is a view illustrating the maximum value of a high-level or low-level continuous time of the TKC signal acquired by a continuous time acquisition section 511a.

FIG. 17 is a flowchart illustrating the operation of the optical disc playback apparatus 500 of Embodiment 5.

FIG. 18 is a block diagram of an optical disc playback apparatus 600 of Embodiment 6 of the present invention.

FIG. 19 is a view illustrating how the amplitude of the TE signal varies every period of eccentricity

FIG. 20 is a flowchart illustrating the operation of the optical disc playback apparatus 600 of Embodiment 6.

FIG. 21 is a block diagram of an optical disc playback apparatus 700 of Embodiment 7 of the present invention.

FIG. 22 is a flowchart illustrating the operation of the optical disc playback apparatus 700 of Embodiment 7.

FIG. 23 is a block diagram of an optical disc playback apparatus 800 of Embodiment 8 of the present invention.

FIGS. 24A to 24C are views illustrating tracking by a 3-beam method.

FIG. 25 is a view illustrating tracking by a DPD method.

FIG. 26 is a view illustrating the relationship between the mount position of a support shaft and a variation in TE signal.

### DESCRIPTION OF THE PREFERRED EMBODIMENTS

Hereinafter, preferred embodiments of the present invention will be described with reference to the accompanying drawings. Note that in the following description, components having substantially the same functions are denoted by the same reference numerals, and description of such components will not be made repeatedly.

### Embodiment 1

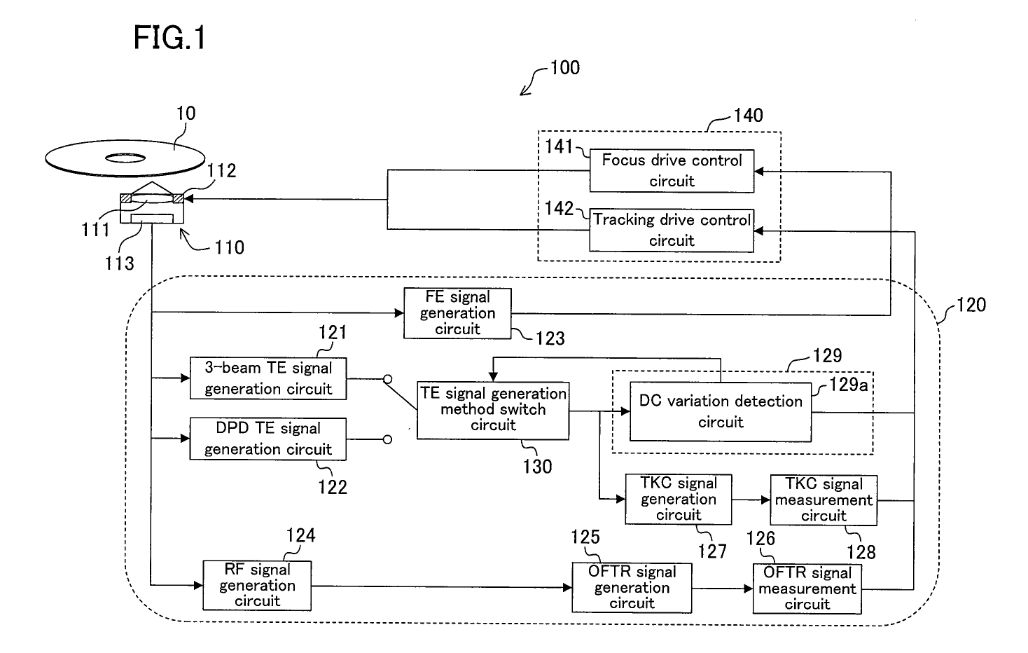

FIG. 1 is a block diagram of an optical disc playback apparatus 100 of Embodiment 1 of the present invention. Referring to FIG. 1, the optical disc playback apparatus 100 includes an optical pickup 110, a signal processing device 120 and an optical pickup drive device 140.

(Configuration of Optical Pickup 110)

The optical pickup 110, adapted to convert reflected light of laser light emitted onto an optical disc 10 to voltage data, includes a convergence lens 111, actuators 112 and an optical detector 113.

The convergence lens 111 allows laser light emitted from a light source toward the optical disc 10 to converge on the optical disc 10.

The actuators 112, one for focusing and the other for tracking, move the convergence lens 111 under the control of the optical pickup drive device 140.

The optical detector 113 converts reflected light of laser light emitted onto the optical disc 10 to voltage data.

(Configuration of Signal Processing Device 120)

The signal processing device 120 outputs a signal representing a positional error in the tracking direction between the laser converging point and the recording plane of the optical disc (this signal is hereinafter called a TE signal). To state more precisely, the signal processing device 120 outputs a TE signal by the 3-beam method initially, and if detecting a variation in the TE signal by the 3-beam method, switches the TE signal generation method to the DPD method, to output a TE signal by the DPD method. Specifically, the signal processing device 120 includes a 3-beam TE signal generation circuit 121, a DPD TE signal generation circuit 122, a FE signal generation circuit 123, an RF signal generation circuit 124, an OFTR signal generation circuit 125, an OFTR signal measurement circuit 126, a TKC signal generation circuit 127, a TKC signal measurement circuit 128, a TE signal variation detection circuit 129 and a TE signal generation method switch circuit 130.

The 3-beam TE signal generation circuit 121 generates a TE signal by the 3-beam method, which signal is herein called a 3-beam TE signal.

The DPD TE signal generation circuit 122 generates a TE signal by the DPD method, which signal is herein called a DPD TE signal.

The FE signal generation circuit 123 generates a focus error (FE) signal representing a positional error in the focus direction between the laser converging point and the recording plane of the optical disc 10.

The RF signal generation circuit 124 generates an RF signal, which is to be pit information on the recording plane of the optical disc 10, from the output of the optical detector 113.

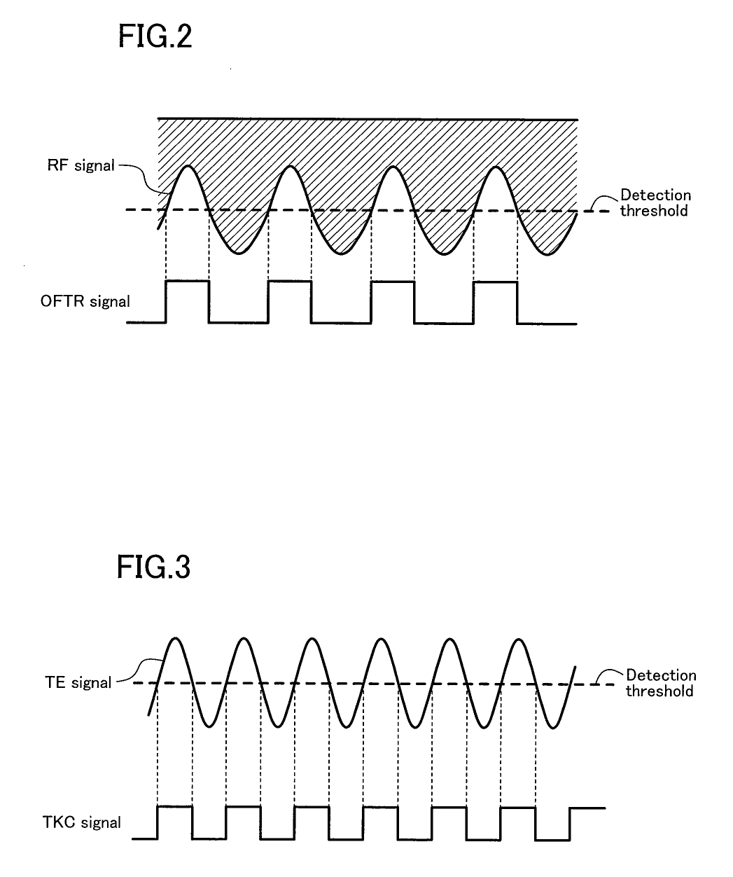

The OFTR signal generation circuit 125 binarizes the RF signal with a predetermined detection threshold, to generate an off-track (OFTR) signal as shown in FIG. 2, which shows the relationship among the RF signal, the OFTR signal and the detection threshold.

The OFTR signal measurement circuit 126 counts the number of times the OFTR signal goes high during a disc rotation period.

The TKC signal generation circuit 127 binarizes the TE signal with a predetermined detection threshold, to generate a tracking cross (TKC) signal as shown in FIG. 3, which shows the relationship among the TE signal, the TKC signal and the detection threshold.

The TKC signal measurement circuit 128 counts the number of times the TKC signal goes high during a disc rotation period.

The TE signal variation detection circuit 129 detects a variation amount of the TE signal, and in this embodiment, specifically, includes a DC variation detection circuit 129a.

The DC variation detection circuit 129a notifies the TE signal generation method switch circuit 130 of detection of a DC variation in the TE signal generated in the 3-beam TE signal generation circuit 121 if detecting such a DC variation. This detection of a DC variation in TE signal is made in the following manner in the DC variation detection circuit 129a.

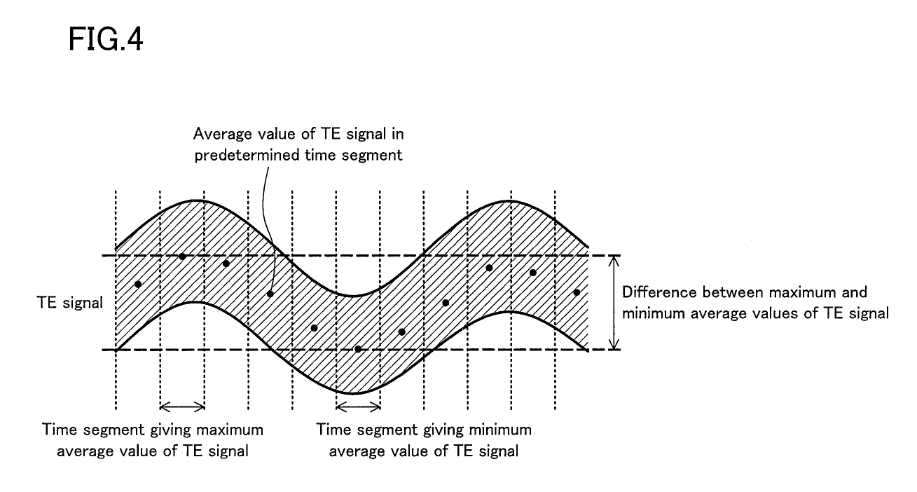

FIG. 4 shows average values of a TE signal in predetermined time segments. First, average values of the 3-beam TE signal in predetermined time segments (for example, segments into which one disc rotation period is divided) are acquired.

Thereafter, the difference between the maximum and minimum values among the average voltage values of the TE signal in the predetermined time segments is acquired. If the difference exceeds a predetermined threshold, the DC variation detection circuit 129a considers that a DC variation has been detected and notifies the TE signal generation method switch circuit 130 of this detection.

The TE signal generation method switch circuit 130 selects either one of the TE signal generated in the 3-beam TE signal generation circuit 121 and the TE signal generated in the DPD TE signal generation circuit 122, and outputs the selected signal. To state more specifically, the TE signal generation method switch circuit 130, receiving the 3-beam TE signal and the DPD TE signal, selects and outputs the 3-beam TE signal initially, and switches the output from the 3-beam TE signal to the DPD TE signal once being notified of detection of a variation in TE signal by the DC variation detection circuit 129a.

(Configuration of Optical Pickup Drive Device 140)

The optical pickup drive device 140 includes a focus drive control circuit 141 and a tracking drive control circuit 142.

The focus drive control circuit 141 controls the actuator for focusing in response to a FE signal to drive the convergence lens 111.

The tracking drive control circuit 142 controls the actuator for tracking in response to the TE signal to drive the convergence lens 111. To state more specifically, the tracking drive control circuit 142 determines the travel direction of the optical pickup from the phase relationship between the TKC signal and the OFTR signal, and controls the actuator for tracking so that the TE signal as the positional error becomes 0.

(Operation of Optical Disc Playback Apparatus 100)

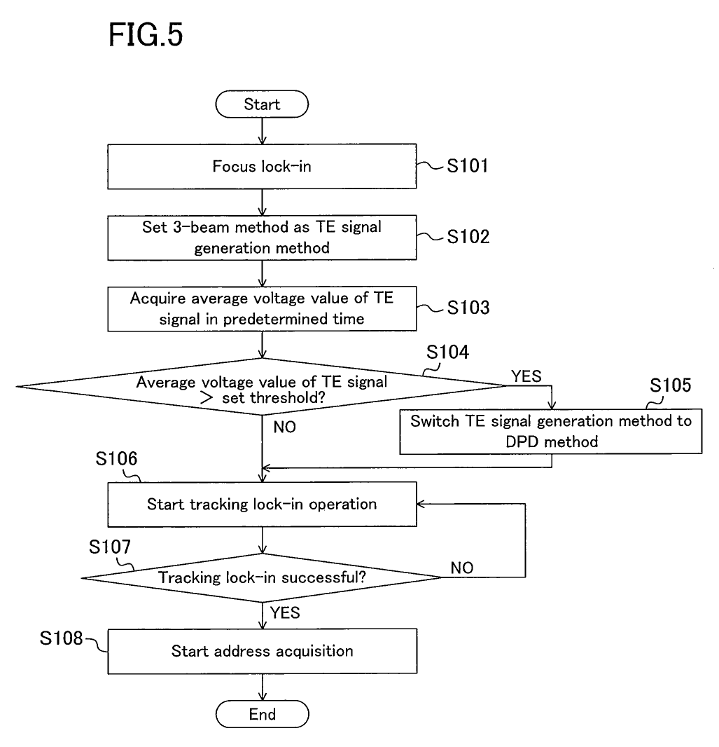

FIG. 5 is a flowchart of the operation of the optical disc playback apparatus 100. The operation will be described step by step as follows.

In step S101, focus lock-in is performed.

In step S102, the 3-beam method is set as the TE signal generation method in the initial state. More specifically, the TE signal generation method switch circuit 130 selects the output of the 3-beam TE signal generation circuit 121 and outputs the selected signal to both the TKC signal generation circuit 127 and the DC variation detection circuit 129a.

In step S103, the DC variation detection circuit 129a calculates an average voltage value of the TE signal.

In step S104, if the average voltage value of the TE signal is greater than a predetermined threshold, the DC variation detection circuit 129a considers that a DC variation has been detected in TE signal and notifies the TE signal generation method switch circuit 130 of this detection.

In step S105, once being notified of detection of a DC variation in TE signal, the TE signal generation method switch circuit 130 selects the output of the DPD TE signal generation circuit 122 and outputs the DPD TE signal to both the TKC signal generation circuit 127 and the DC variation detection circuit 129a.

In step S106, tracking lock-in is started. In step S107, success or failure of the tracking is verified. If the tracking lock-in has failed, the process returns to the step S106 to perform tracking lock-in again. If the tracking lock-in is successful, the process proceeds to step S108, where an address is acquired.

As described above, in this embodiment, in which the TE signal generation method is selected depending on the variation amount (DC variation amount) of the TE signal, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

### Embodiment 2

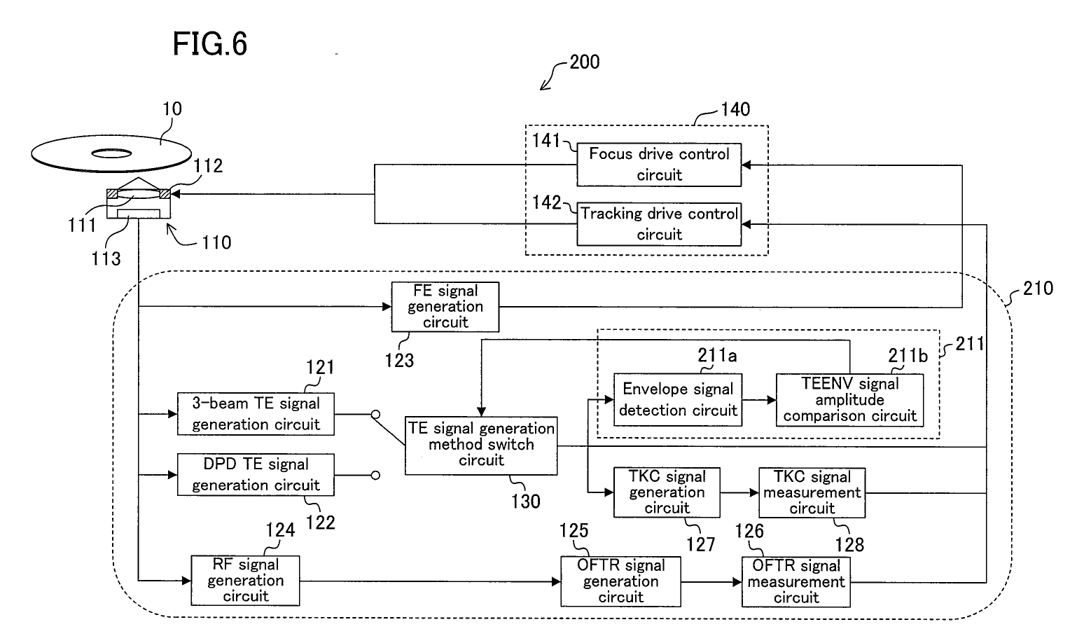

FIG. 6 is a block diagram of an optical disc playback apparatus 200 of Embodiment 2 of the present invention. The optical disc playback apparatus 200 is different from the optical disc playback apparatus 100 of Embodiment 1 in the way of detecting a variation in TE signal. As shown in FIG. 6, the optical disc playback apparatus 200 includes a signal processing device 210 in place of the signal processing device 120 of the optical disc playback apparatus 100.

The signal processing device 210 includes a TE signal variation detection circuit 211 in place of the TE signal variation detection circuit 129 of the signal processing device 120. The TE signal variation detection circuit 211 includes an envelope signal detection circuit 211a and a TEENV signal amplitude comparison circuit 211b.

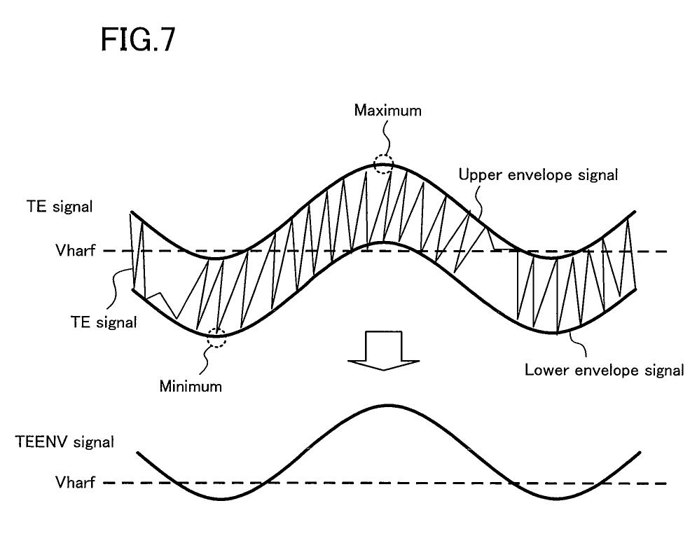

The envelope signal detection circuit 211a generates a tracking envelope (TEENV) signal from the 3-beam TE signal. More specifically, as shown in FIG. 7, the envelope signal detection circuit 211a extracts an upper envelope signal or a lower envelope signal from the TE signal, to generate a TEENV signal.

The TEENV signal amplitude comparison circuit 211b, receiving the TEENV signal from the envelope signal detection circuit 211a, acquires the maximum and minimum values of the TEENV signal in a set time period (for example, one of several time segments into which one disc rotation period is divided). If the difference between the maximum and minimum values of the TEENV signal exceeds a predetermined threshold, the TEENV signal amplitude comparison circuit 211b notifies the TE signal generation method switch circuit 130 of detection of a variation in TE signal.

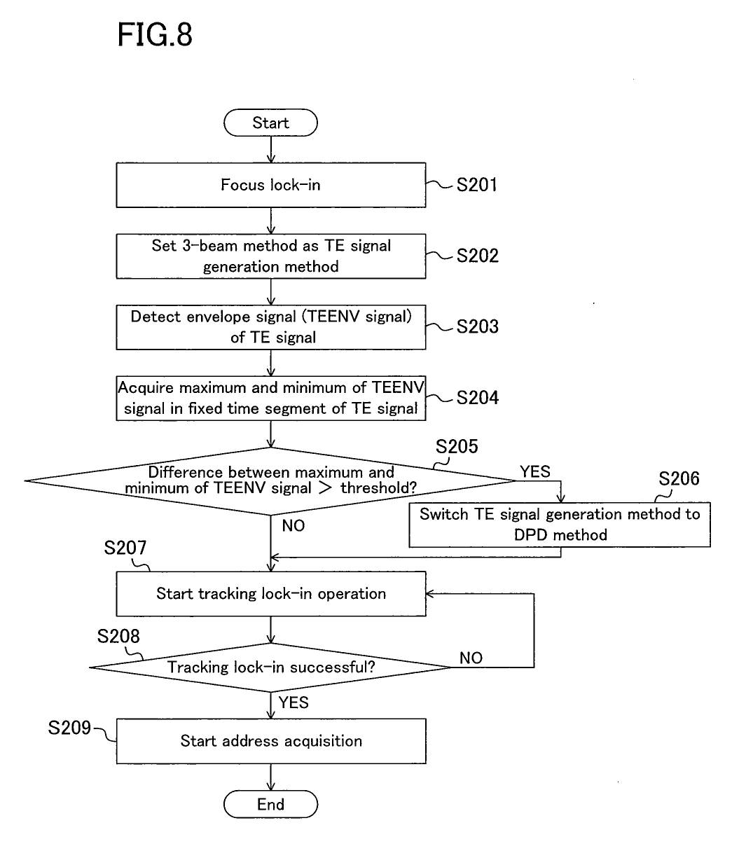

FIG. 8 is a flowchart of the operation of the optical disc playback apparatus 200. Steps S201, S202 and S206 to S209 in FIG. 8 are respectively the same in processing as the steps S101, S102 and S105 to S108 in FIG. 5. In other words, processing in steps S203 to S205 is different from the processing performed in the optical disc playback apparatus 100.

In the step S203, the envelope signal detection circuit 211a generates a TEENV signal. In the step S204, the TEENV signal amplitude comparison circuit 211b acquires the maximum and minimum values of the TEENV signal in a set time (for example, one of several time segments into which one disc rotation period is divided). In the step S205, the TEENV signal amplitude comparison circuit 211b notifies the TE signal generation method switch circuit 130 of detection of a variation in TE signal if the difference between the maximum and minimum values of the TEENV signal exceeds a predetermined threshold.

The TE signal generation method switch circuit 130 switches the TE signal generation method from the 3-beam method to the DPD method once being notified of detection of a variation in TE signal. In other words, the TE signal generation method switch circuit 130 switches the TE signal generation method depending on the variation amount of the TE signal.

As described above, in this embodiment, in which also the TE signal generation method is selected depending on the variation amount of the TE signal, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

The envelope signal detection circuit 211a may otherwise be configured to extract both the upper and lower envelope signals, and the TEENV signal amplitude comparison circuit 211b may notify the TE signal generation method switch circuit 130 of detection of a variation in TE signal if the difference between the maximum value of the upper envelope signal and the minimum value of the lower envelope signal in a set time exceeds a predetermined threshold.

### Embodiment 3

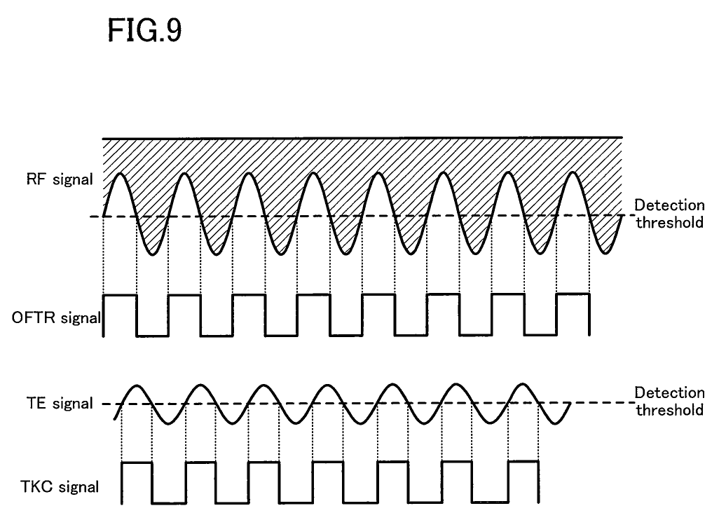

The OFTR signal is a signal obtained by binarizing the RF signal with a predetermined threshold, and the TKC signal is a signal obtained by binarizing the TE signal with a predetermined threshold. As is apparent from FIG. 9, the RF signal and the TE signal are deviated in phase from each other by 90°, and thus the OFTR signal and the TKC signal are also deviated in phase from each other by 90°. When both the OFTR signal and the TKC signal can be detected normally, these signals are the same in the number of times of going high or low. If the difference between the count value of the number of times the TKC signal goes high in a predetermined time and the count value of the number of times the OFTR signal goes high in a predetermined time (difference in high or low level count) exceeds a predetermined threshold, it can be decided that a variation must have occurred in TE signal. In Embodiment 3, this feature is utilized to detect a variation in TE signal.

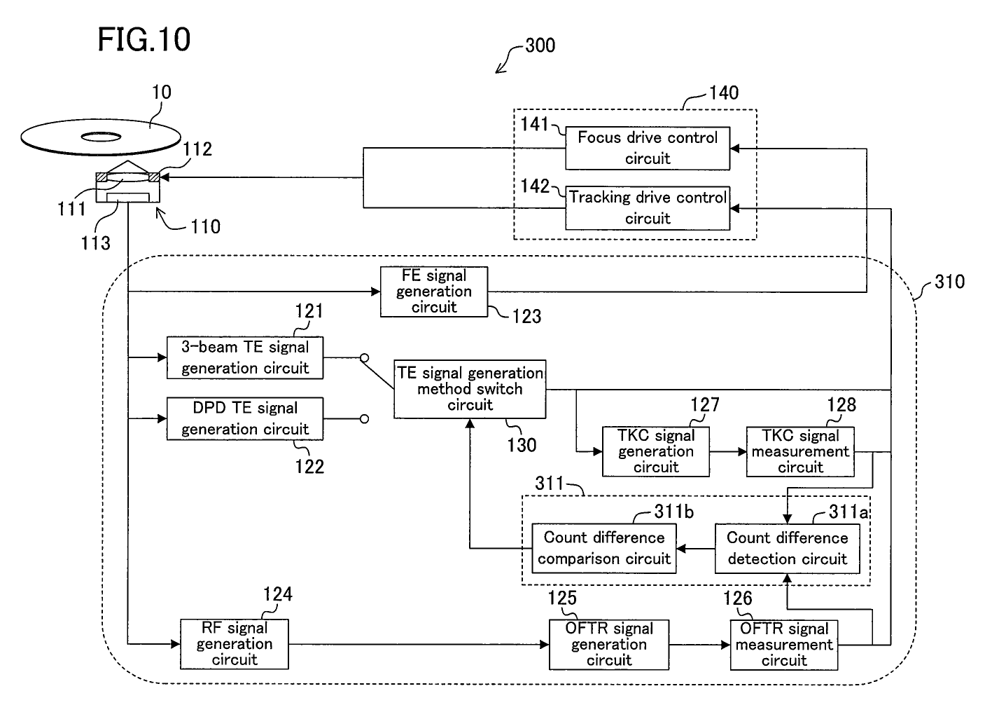

FIG. 10 is a block diagram of an optical disc playback apparatus 300 of Embodiment 3 of the present invention. As shown in FIG. 10, the optical disc playback apparatus 300 includes a signal processing device 310 in place of the signal processing device 120 of the optical disc playback apparatus 100.

The signal processing device 310 includes a TE signal variation detection circuit 311 in place of the TE signal variation detection circuit 129 of the signal processing device 120. The TE signal variation detection circuit 311 includes a count difference detection circuit 311a and a count difference comparison circuit 311b.

The count difference detection circuit 311a receives the number of times the TKC signal goes high counted by the TKC signal measurement circuit 128 and the number of times the OFTR signal goes high counted by the OFTR signal measurement circuit 126, and calculates the difference therebetween.

The count difference comparison circuit 311b notifies the TE signal generation method switch circuit 130 of detection of a variation in TE signal if the difference value calculated by the count difference detection circuit 311a exceeds a predetermined threshold.

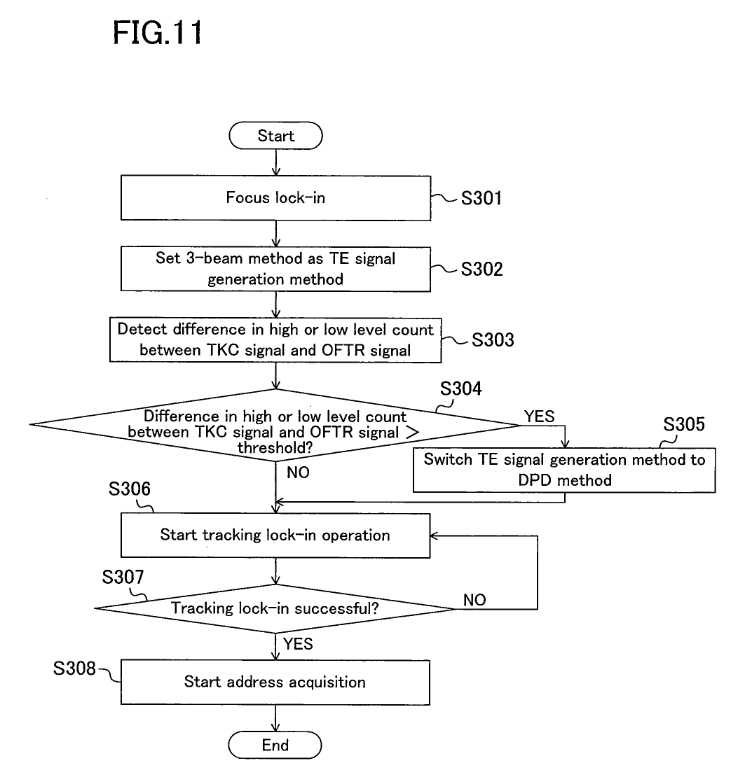

FIG. 11 is a flowchart of the operation of the optical disc playback apparatus 300. Steps S301, S302 and S305 to S308 in FIG. 11 are respectively the same in processing as the steps S101, S102 and S105 to S108 in FIG. 5. In other words, processing in steps S303 and S304 is different from the processing performed in the optical disc playback apparatus 100.

In the step S303, the count difference detection circuit 311a calculates the difference between the number of times the TKC signal goes high and the number of times the OFTR signal goes high. In the step S304, the count difference comparison circuit 311b notifies the TE signal generation method switch circuit 130 of detection of a variation in TE signal if the difference value calculated by the count difference detection circuit 311a exceeds a predetermined threshold.

The TE signal generation method switch circuit 130 switches the TE signal generation method from the 3-beam method to the DPD method once being notified of detection of a variation in TE signal. In other words, the TE signal generation method switch circuit 130 switches the TE signal generation method depending on the variation amount of the TE signal.

As described above, in this embodiment, in which also the TE signal generation method is selected depending on the variation amount of the TE signal, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

### Embodiment 4

In this embodiment, the way of setting the threshold used in the TKC signal generation circuit 127 in Embodiment 3 will be described.

For the setting of the threshold used for generation of the TKC signal in the TKC signal generation circuit 127, a DC following threshold scheme or a fixed threshold scheme may be adopted.

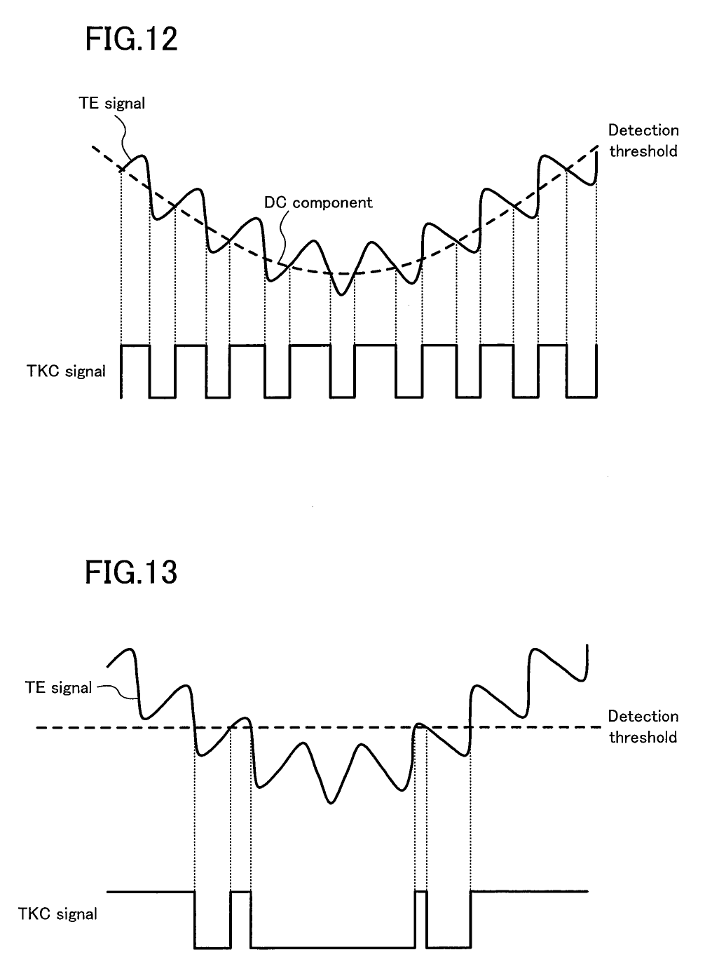

In the DC following threshold scheme, as shown in FIG. 12, the TE signal is subjected to low-pass filtering (LPF) to extract only the DC component of the TE signal. The value of the extracted DC component is used as the threshold for generation of the TKC signal. Having this threshold, the TE signal can be accurately binarized to generate the TKC signal even if the TE signal has a DC variation.

In the fixed threshold scheme, as shown in FIG. 13, the TE signal is binarized with a predetermined threshold (fixed threshold) to generate the TKC signal.

Having a fixed threshold, the TCK signal cannot be accurately generated if the TE signal is influenced by the DC component.

For example, when the DC following threshold scheme is adopted in generation of the TKC signal, the TKC signal may be generated normally even if the TE signal varies because the variation is followed. It is therefore unable to detect the abnormality in the TE signal. Accordingly, in the method described in Embodiment 3, in which the TE signal generation method is to be switched if the difference between the count value of the number of times the TKC signal goes high in a predetermined time and the count value of the number of times the OFTR signal goes high in a predetermined time exceeds a predetermined threshold, it is unable to switch the TE signal generation method from the 3-beam method to the DPD method, and as a result, tracking lock-in may possibly become unstable. Hence, in this embodiment, in detection of deterioration and variation in TE signal, the way of setting the threshold is switched from the DC following threshold scheme to the fixed threshold scheme.

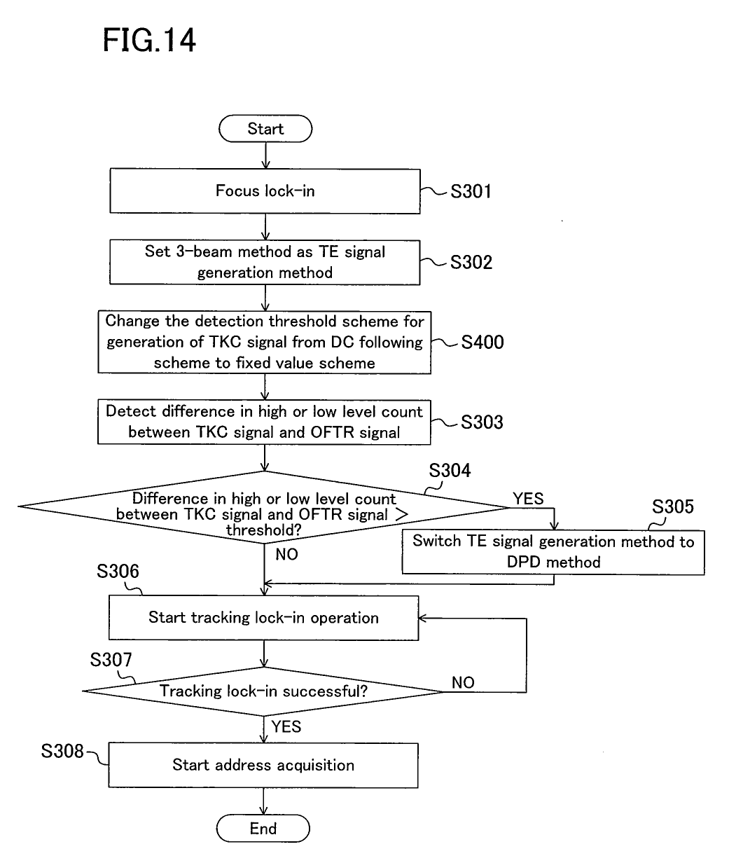

FIG. 14 is a flowchart of the operation of an optical disc playback apparatus of Embodiment 4. The flowchart of FIG. 14 is different from the flowchart in Embodiment 3 (FIG. 11) in that step S400 is added between the steps S302 and S303.

In the step S400, the way of setting the threshold used for generation of the TKC signal is changed to the fixed threshold scheme. With this setting, the TKC signal will not be generated normally if the TE signal is found deteriorating or varying. This makes the difference in high or low level count between the TKC signal and the OFTR signal manifest itself clearly, and thus precise determination can be made.

### Embodiment 5

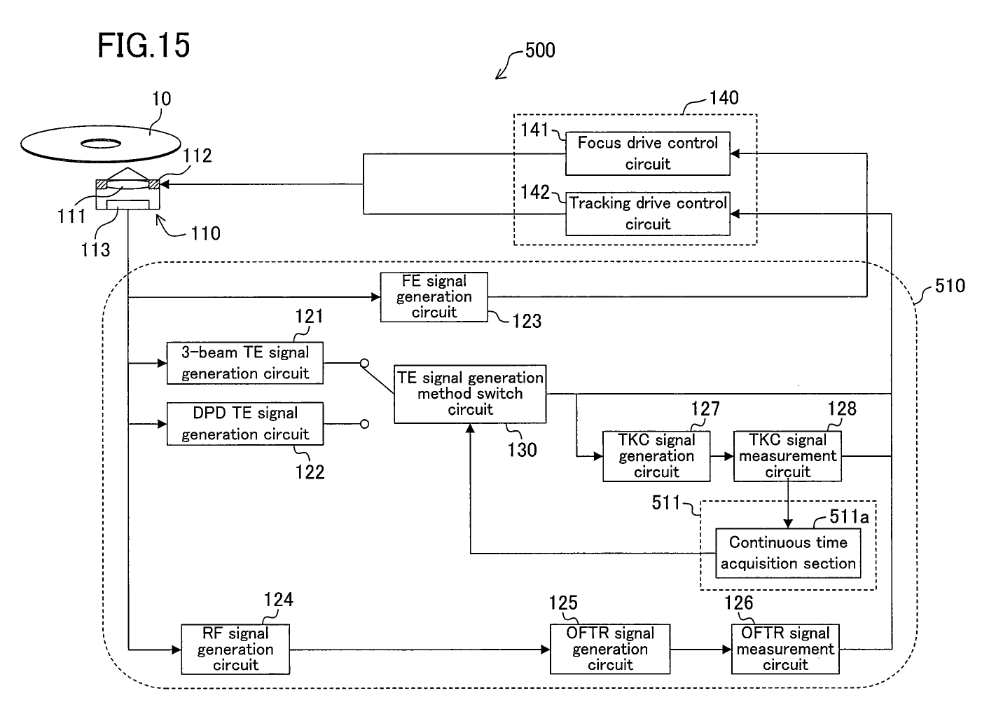

FIG. 15 is a block diagram of an optical disc playback apparatus 500 of Embodiment 5 of the present invention. As shown in FIG. 15, the optical disc playback apparatus 500 includes a signal processing device 510 in place of the signal processing device 120 of the optical disc playback apparatus 100.

The signal processing device 510 includes a TE signal variation detection circuit 511 in place of the TE signal variation detection circuit 129 of the signal processing device 120. The TE signal variation detection circuit 511 includes a continuous time acquisition section 511a.

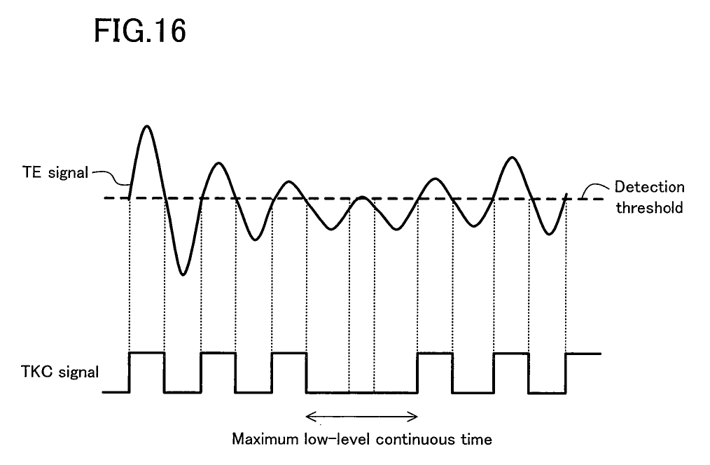

The continuous time acquisition section 511a acquires the maximum value of high-level continuous time or low-level continuous time of the TKC signal in a predetermined time (for example, one disc rotation time), as shown in FIG. 16, and notifies the TE signal generation method switch circuit 130 of detection of a variation in TE signal if the maximum value acquired is equal to or greater than a predetermined threshold (F).

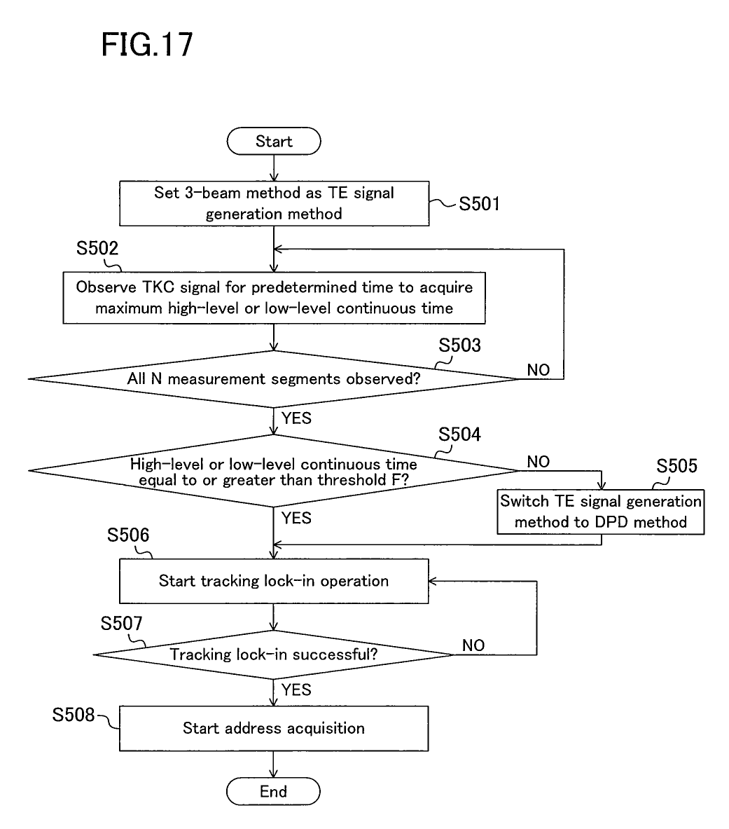

FIG. 17 is a flowchart of the operation of the optical disc playback apparatus 500. Steps S501 and S505 to S508 in FIG. 17 are respectively the same in processing as the steps S102 and S105 to S108 in FIG. 5. In other words, processing in steps S502 to S504 is different from the processing performed in the optical disc playback apparatus 100.

In the step S502, the continuous time acquisition section 511a observes the TKC signal for a predetermined time to acquire the maximum value of high-level continuous time or low-level continuous time. In step S504, the continuous time acquisition section 511a compares the acquired maximum value of continuous time with the threshold (F), and notifies the TE signal generation method switch circuit 130 of detection of a variation in TE signal if the maximum value is equal to or greater than the threshold (F) The TE signal generation method switch circuit 130 switches the TE signal generation method from the 3-beam method to the DPD method once being notified of detection of a variation in TE signal (step S505). In other words, the TE signal generation method switch circuit 130 switches the TE signal generation method depending on the variation amount of the TE signal to generate the TE signal.

As described above, in this embodiment, in which also the TE signal generation method is selected depending on the variation amount of the TE signal, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

### Embodiment 6

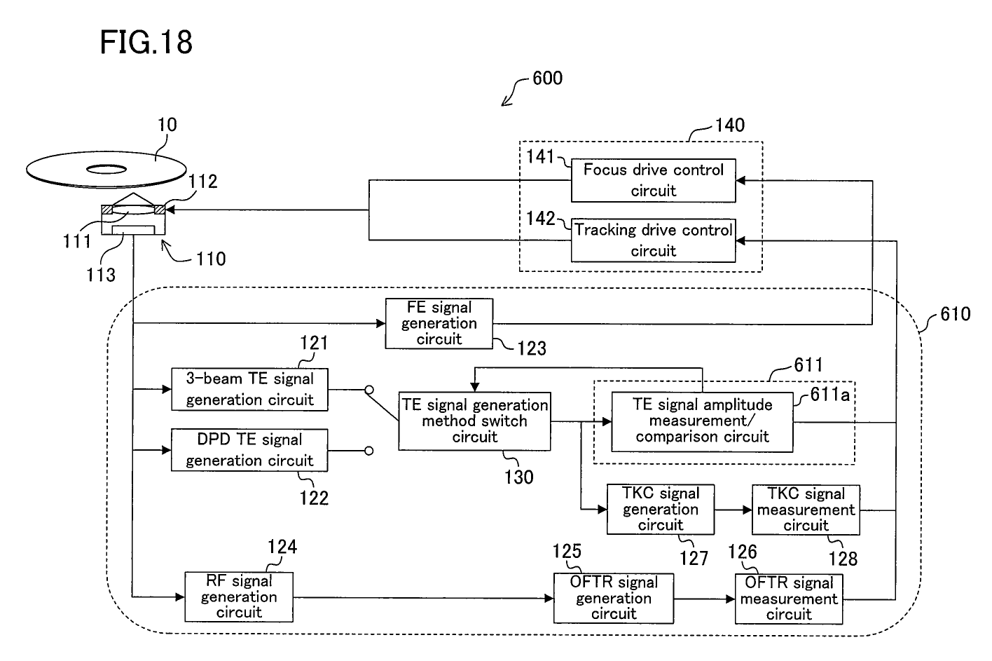

FIG. 18 is a block diagram of an optical disc playback apparatus 600 of Embodiment 6 of the present invention. As shown in FIG. 18, the optical disc playback apparatus 600 includes a signal processing device 610 in place of the signal processing device 120 of the optical disc playback apparatus 100.

The signal processing device 610 includes a TE signal variation detection circuit 611 in place of the TE signal variation detection circuit 129 of the signal processing device 120. The TE signal variation detection circuit 611 includes a TE signal amplitude measurement/comparison section 611a.

The TE signal amplitude measurement/comparison section 611a divides a predetermined time (for example, one disc rotation time) into given measurement segments and acquires the maximum and minimum values of the TE signal in each measurement segment to calculate the amplitude value of the TE signal. The TE signal amplitude measurement/comparison section 611a notifies the TE signal generation method switch circuit 130 of detection of a variation in TE signal if the minimum amplitude value of the TE signal is equal to or smaller than a threshold (E).

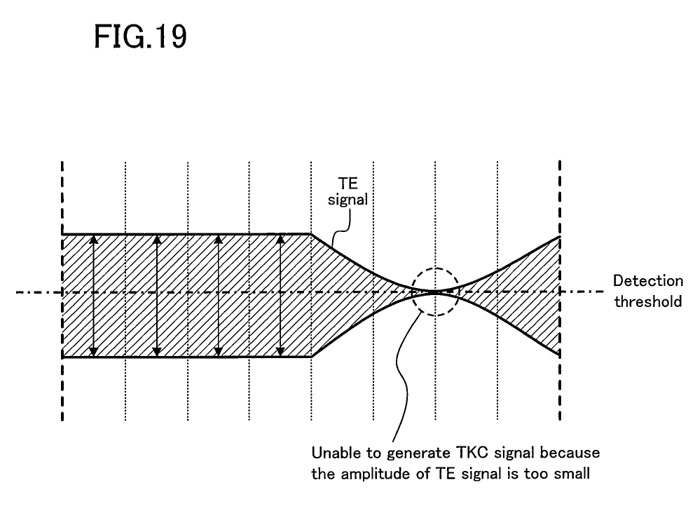

For example, when the amplitude of the TE signal is small as shown in FIG. 19, which shows how the amplitude of the TE signal varies every period of eccentricity, the TKC signal will have dropouts, failing to generate the TKC signal normally. Tracking lock-in will therefore fail. In Embodiment 6, therefore, the amplitude value of the TE signal is obtained for switching of the TE signal generation method.

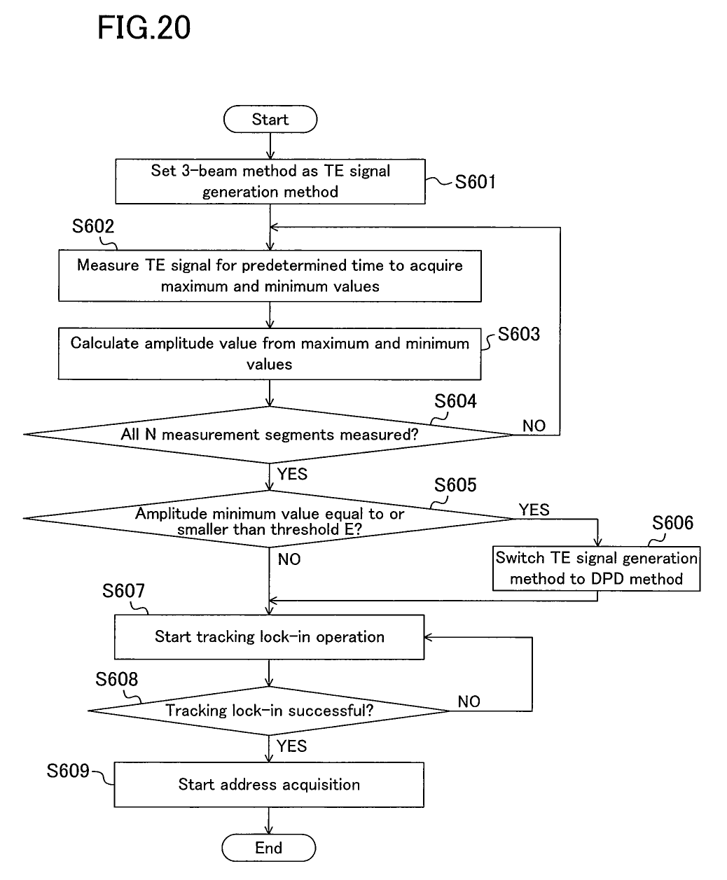

FIG. 20 is a flowchart of the operation of the optical disc playback apparatus 600. Steps S601 and S606 to S609 in FIG. 20 are respectively the same in processing as the steps S102 and S105 to S108 in FIG. 5. In other words, processing in steps S602 to S605 is different from the processing performed in the optical disc playback apparatus 100. Assume in this example that there are a total of N measurement segments.

In the step S602, the TE signal amplitude measurement/comparison circuit 611a acquires the maximum and minimum values of the TE signal in the current measurement segment. In the step S603, the TE signal amplitude measurement/comparison circuit 611a calculates the amplitude value from the acquired maximum and minimum values. In the step S604, whether or not the amplitude value has been calculated for all the N measurement segments is determined. If it has not been calculated for all the segments, the process returns to the step S602. If it has been calculated for all the segments, the process proceeds to the step S605.

In the step S605, the TE signal amplitude measurement/comparison circuit 611a compares the minimum value of the amplitude values with the threshold (E), and notifies the TE signal generation method switch circuit 130 of detection of a variation in TE signal if the minimum amplitude value is equal to or smaller than the threshold (E).

The TE signal generation method switch circuit 130 switches the TE signal generation method from the 3-beam method to the DPD method once being notified of detection of a variation in TE signal (step S606). In other words, the TE signal generation method switch circuit 130 switches the TE signal generation method depending on the variation amount of the TE signal to generate the TE signal.

As described above, in this embodiment, in which also the TE signal generation method is selected depending on the variation amount of the TE signal, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

### Embodiment 7

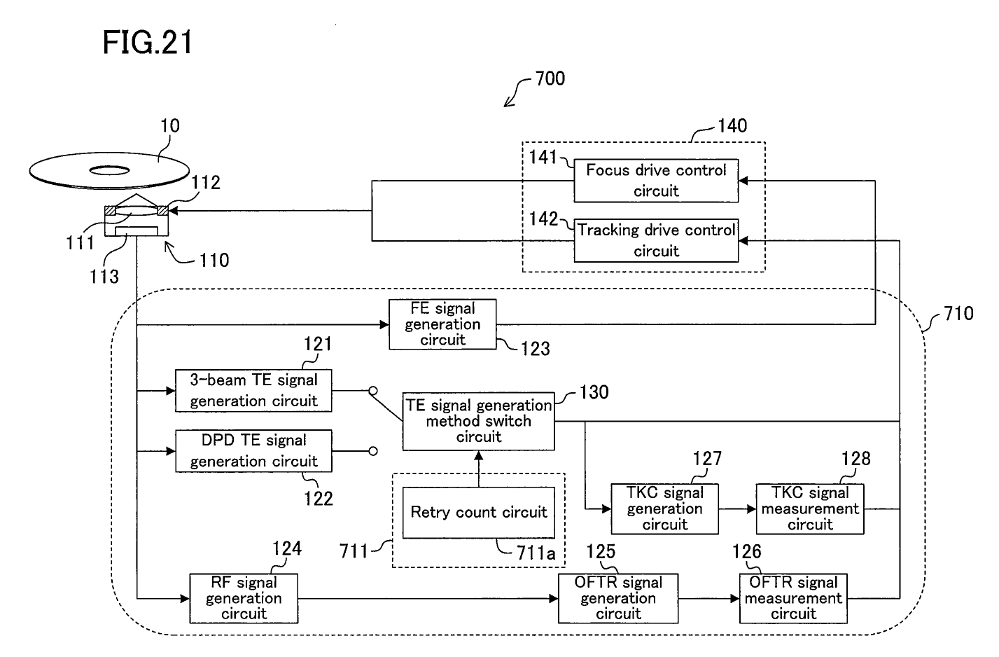

FIG. 21 is a block diagram of an optical disc playback apparatus 700 of Embodiment 7 of the present invention. As shown in FIG. 21, the optical disc playback apparatus 700 includes a signal processing device 710 in place of the signal processing device 120 of the optical disc playback apparatus 100. Note that the optical disc playback apparatus 700 is configured to retry tracking lock-in if failing.

The signal processing device 710 includes a TE signal variation detection circuit 711 in place of the TE signal variation detection circuit 129 of the signal processing device 120. The TE signal variation detection circuit 711 includes a retry count circuit 711a.

The retry count circuit 711a counts the number of retries after failure in tracking lock-in in the 3-beam method. The retry count circuit 711a has a retry counter for counting the number of retries, and notifies the TE signal generation method switch circuit 130 of detection of a variation in TE signal if the number of retries exceeds a predetermined threshold (D).

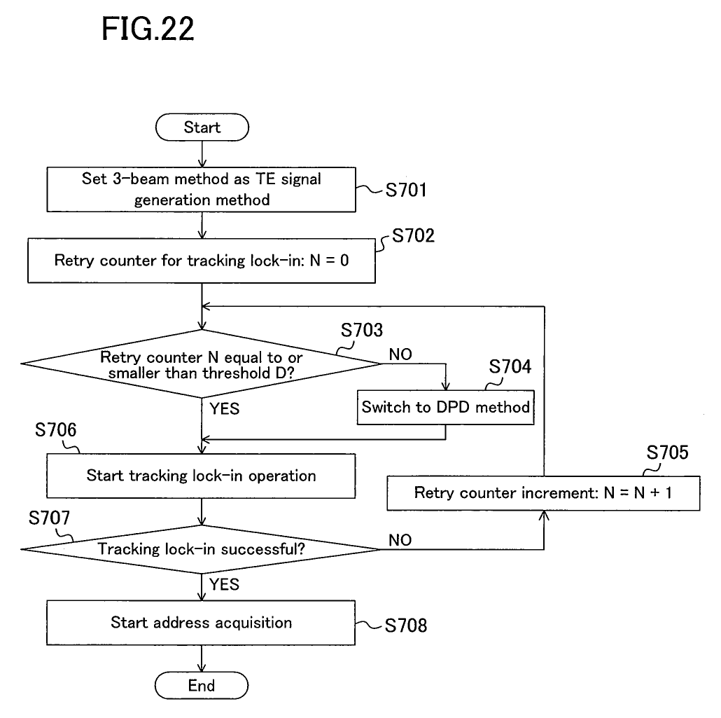

FIG. 22 is a flowchart of the operation of the optical disc playback apparatus 700. In step S701, the 3-beam method is set as the TE signal generation method. In step S702, the retry count circuit 711a resets the retry counter to 0.

In step S703, the retry count circuit 711a compares the number of retries with the threshold (D). If the number of retries exceeds the threshold (D), the process proceeds to step S704, to switch the TE signal generation method to the DPD method. If the number of retries is equal to or smaller than the threshold (D), the process proceeds to step S706, to start tracking lock-in operation.

In step S707, success or failure of the tracking lock-in is verified. If the tracking lock-in has failed, the process proceeds to step S705, to allow the retry count circuit 711a to increment the retry counter, and then returns to the step S703. If the tracking lock-in is successful, the process proceeds to step S708, to acquire an address.

As described above, in this embodiment, in which the TE signal generation method is selected depending on the number of retries of tracking, a stable tracking signal can be generated. Accordingly, stable playback is ensured even when the mechanism is poor in the precision of tangential adjustment, when an eccentric disc or a disc narrow in track pitch is used for playback, or when such a mechanism and such a disc are combined.

### Embodiment 8

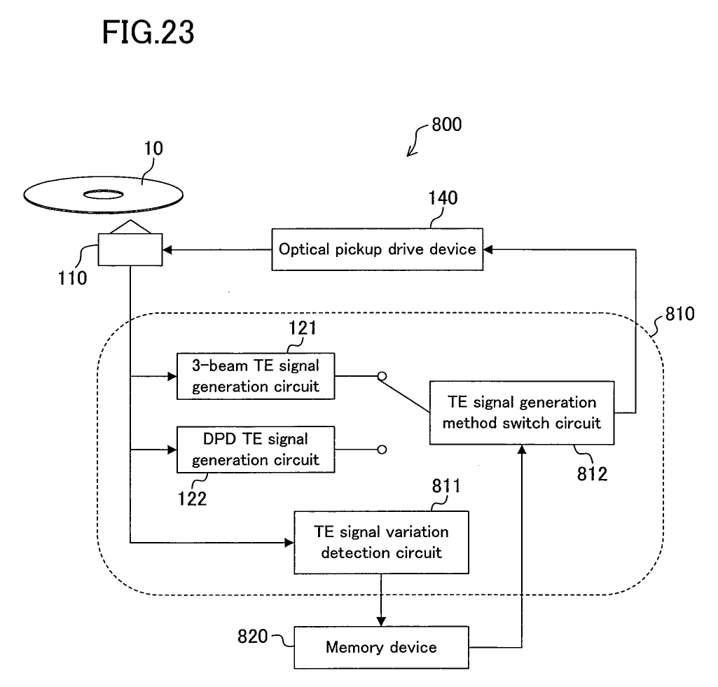

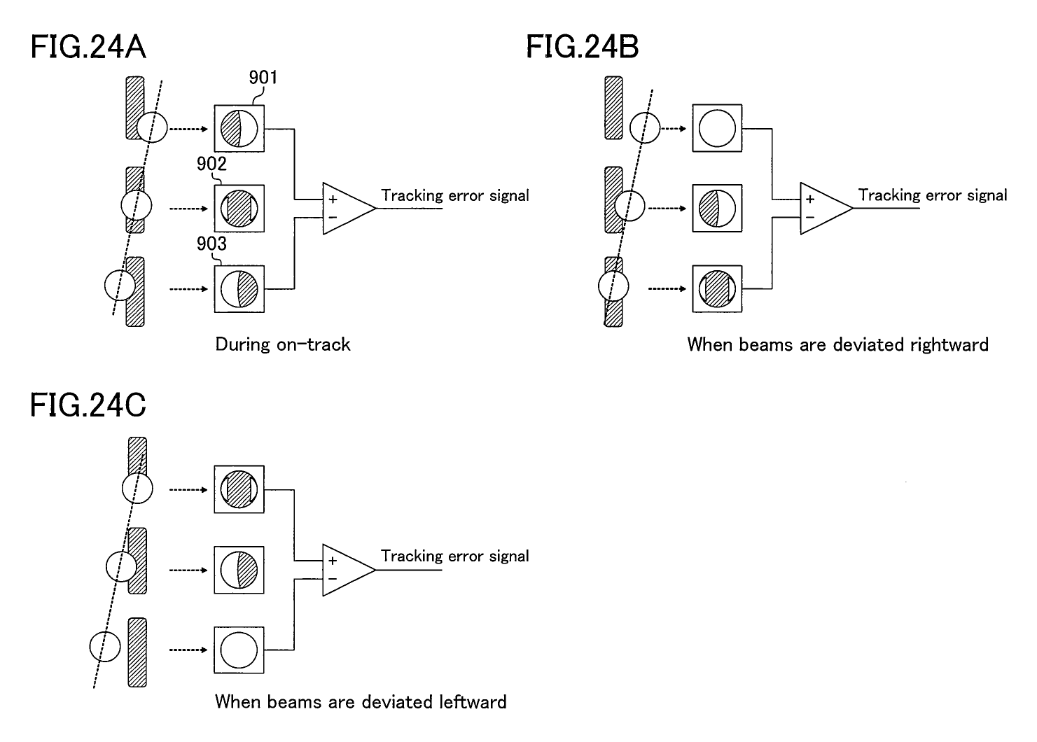

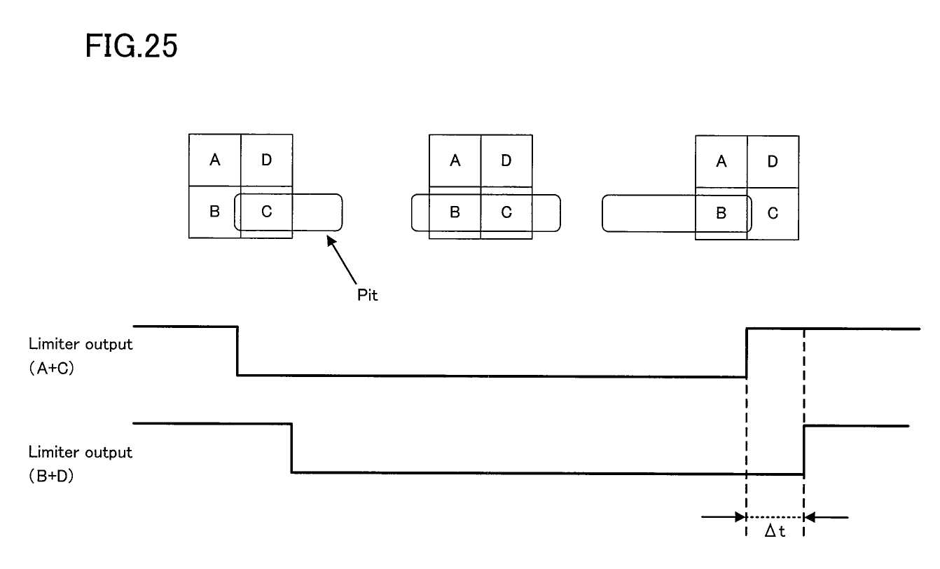

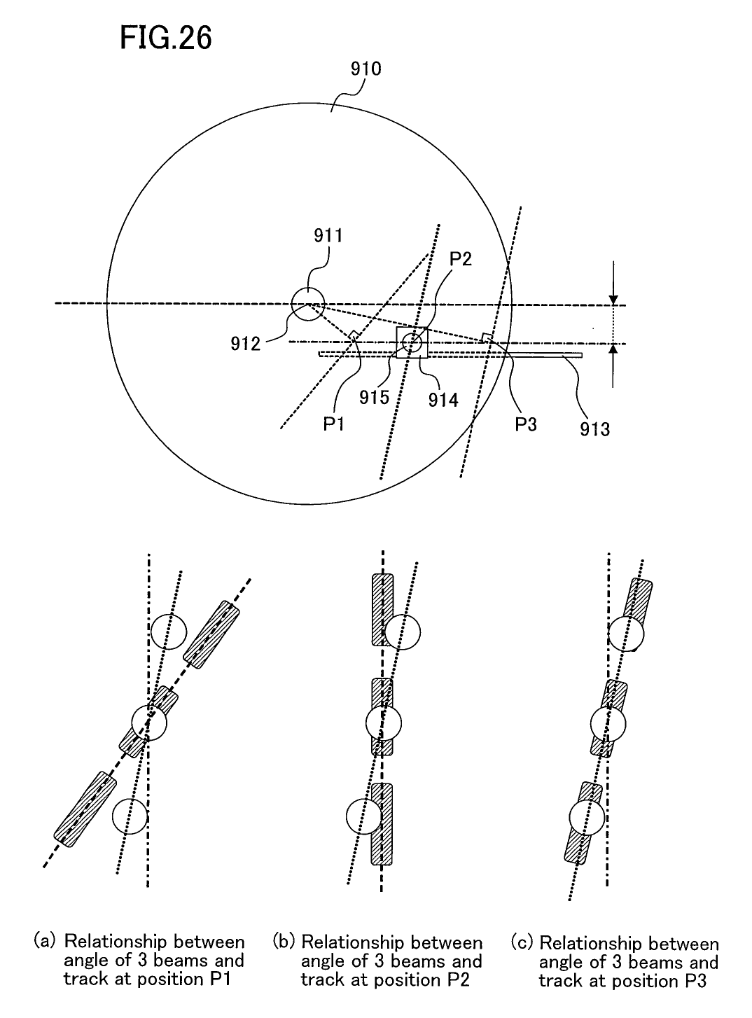

FIG. 23 is a block diagram of an optical disc playback apparatus 800 of Embodiment 8 of the present invention. As shown in FIG. 23, the optical disc playback apparatus 800 includes an optical pickup 110, an optical pickup drive device 140, a signal processing device 810 and a memory device 820.

The signal processing device 810 includes a 3-beam TE signal generation circuit 121, a DPD TE signal generation circuit 122, a TE signal variation detection circuit 811 and a TE signal generation method switch circuit 812.

The TE signal variation detection circuit 811 may be any one or more of the DC variation detection circuits described in Embodiments 1 to 7. If the TE signal variation detection circuit 811 has a plurality of DC variation detection circuits, every time any of the DC variation detection circuits detects a variation in TE signal, the detected result is outputted to the memory device 820.

The memory device 820 stores information on variation in TE signal detected by the TE signal variation detection circuit 811. In the case of the TE signal variation detection circuit 811 having a plurality of DC variation detection circuits, information detected by any DC variation detection circuit is stored.

The TE signal generation method switch circuit 812 selects either one of the TE signal generated by the 3-beam TE signal generation circuit 121 and the TE signal generated by the DPD TE signal generation circuit 122, depending on the information stored in the memory device 820, and outputs the selected signal.

In the optical disc playback apparatus 800, once detecting a variation in TE signal, the TE signal variation detection circuit 811 stores the information in the memory device 820. The TE signal generation method switch circuit 812 determines the TE signal generation method by referring to the information stored in the memory device 820.

As described above, the signal processing device according to the present invention has an effect of permitting generation of a stable tracking error signal. Accordingly, the inventive signal processing device is useful as a signal processing device and the like for generating a tracking error signal in an optical disc playback apparatus for playing back optical information.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A signal processing device comprising:
a 3-beam TE signal generation circuit for generating a 3-beam tracking error signal as a tracking error signal by a 3-beam method;
a DPD TE signal generation circuit for generating a DPD tracking error signal as a tracking error signal by a DPD method;
a TE signal variation detection circuit for detecting a variation in the 3-beam tracking error signal; and
a TE signal generation method switch circuit receiving the 3-beam tracking error signal and the DPD tracking error signal for selecting and outputting the 3-beam tracking error signal initially and, if the TE signal variation detection circuit detects a variation, selecting and outputting the DPD tracking error signal.

2. The device of claim 1, wherein the TE signal variation detection circuit detects a DC variation in the 3-beam tracking error signal.

3. The device of claim 2, wherein the TE signal variation detection circuit detects a DC variation in the 3-beam tracking error signal based on whether or not the difference between the maximum and minimum values of voltage values of the 3-beam tracking error signal in a predetermined time exceeds a predetermined threshold.

4. The device of claim 2, wherein the TE signal variation detection circuit detects a DC variation in the 3-beam tracking error signal based on whether or not the difference between the maximum and minimum values of average voltage values of the 3-beam tracking error signal in a predetermined time exceeds a predetermined threshold.

5. The device of claim 2, wherein the TE signal variation detection circuit detects a DC variation in the 3-beam tracking error signal based on whether or not the difference between the maximum and minimum values of an envelope signal of the 3-beam tracking error signal in a predetermined time exceeds a predetermined threshold.

6. The device of claim 1, wherein the TE signal variation detection circuit receives a tracking cross signal as a signal obtained by binarizing the 3-beam tracking error signal with a predetermined binarizing threshold and a off-track signal as a signal obtained by binarizing a signal representing pit information on a recording plane of an optical disc with a predetermined binarizing threshold, and detects a variation based on whether or not the difference in high or low level count between the tracking cross signal and the off-track signal in a predetermined time exceeds a predetermined detection threshold.

7. The device of claim 6, wherein the TE signal variation detection circuit sets the detection threshold according to a DC following threshold scheme initially and, at the time of determining the difference in high or low level count, sets the detection threshold according to a fixed threshold scheme.

8. The device of claim 1, wherein the TE signal variation detection circuit receives a tracking cross signal as a signal obtained by binarizing the 3-beam tracking error signal with a predetermined binarizing threshold, and detects a variation based on the maximum value of high-level continuous time or low-level continuous time of the tracking cross signal in a predetermined time.

9. The device of claim 1, wherein the TE signal variation detection circuit detects a variation based on the amplitude of the 3-beam tracking error signal in a predetermined time.

10. The device of claim 1, wherein the TE signal variation detection circuit detects a variation based on the number of times of failure in tracking lock-in operation.

11. An optical disc playback apparatus comprising:
an optical pickup;
an optical pickup drive device; and
a signal processing device for generating a tracking error signal,
wherein the signal processing device comprising:
a 3-beam TE signal generation circuit for generating a 3-beam tracking error signal as a tracking error signal by a 3-beam method;
a DPD TE signal generation circuit for generating a DPD tracking error signal as a tracking error signal by a DPD method;
a TE signal variation detection circuit for detecting a variation in the 3-beam tracking error signal; and
a TE signal generation method switch circuit receiving the 3-beam tracking error signal and the DPD tracking error signal for selecting and outputting the 3-beam tracking error signal initially and, if the TE signal variation detection circuit detects a variation, selecting and outputting the DPD tracking error signal.

12. The apparatus of claim 11, further comprising a memory device for storing a detection result from the TE signal variation detection circuit,
wherein the TE signal generation method switch circuit makes the selection depending on the detection result stored in the memory device.
